(19) United States
(12) Patent Application Publication
(10) Pub. No.: US 2012/0264510 A1
(43) Pub. Date: Oct. 18, 2012

(54) INTEGRATED VIRTUAL ENVIRONMENT

(75) Inventors: Daniel J. Wigdor, Littleton, MA (US); Megan Tedesco, Sammamish, WA (US); Andrew Wilson, Seattle, WA (US); John Clavin, Seattle, WA (US)

(73) Assignee: MICROSOFT CORPORATION, Redmond, WA (US)

(21) Appl. No.: 13/084,786

(22) Filed: Apr. 12, 2011

(51) Int. Cl. A63F 13/00

(52) U.S. Cl. 463/31

(57) ABSTRACT

An integrated virtual environment is provided by obtaining a 3D spatial model of a physical environment in which a user is located, and identifying, via analysis of the 3D spatial model, a physical object in the physical environment. The method further comprises generating a virtualized representation of the physical object, and incorporating the virtualized representation of the physical object into an existing virtual environment, thereby yielding the integrated virtual environment. The method further comprises displaying, on a display device and from a vantage point of the user, a view of the integrated virtual environment, said view being changeable in response to the user moving and/or interacting within the physical environment.

### BACKGROUND

Virtual reality systems exist for simulating virtual environments within which a user may be immersed. Displays such as head-up displays, head-mounted displays, etc., may be utilized to display the virtual environment. Typically, virtual reality systems entail providing the user with a fully virtual experience having no correspondence to the physical environment in which the user is located. In some cases, virtual environments are based on real-world settings, though these systems typically involve pre-experience modeling of the physical environment and are limited in the extent to which real-world features enrich the user's virtual experience.

### SUMMARY

According to one aspect of the disclosure, an integrated virtual environment is displayed on a display device for a user and from the user's vantage point. The integrated virtual environment incorporates virtualized representations of real-world physical objects from the user's environment into an existing virtual environment. The view of the integrated virtual environment may change in response to the user moving within their physical environment and/or interacting with the physical objects in their physical environment.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a perspective view of an example physical environment.

FIG. 2 shows an example integrated virtual environment that corresponds to the physical environment of FIG. 1.

FIG. 3 shows example candidate virtualized representations.

FIG. 4 schematically shows an example spatial relationship incorporating the example environments of FIGS. 1 and 2.

FIG. 5 schematically shows a virtual pipeline generating a virtualized representation of a physical object.

FIG. 6 shows an example of a user moving within the physical environment of FIG. 1.

FIG. 7 shows an example game sequence corresponding to FIG. 6.

FIG. 8 shows an example of a user interacting with the physical environment of FIG. 1.

FIG. 9 shows an example game sequence corresponding to FIG. 8.

FIG. 10 illustrates an example method for displaying an integrated virtual environment.

FIG. 11 illustrates an example method for changing the integrated virtual environment.

FIG. 12 illustrates another example method for changing the integrated virtual environment.

FIG. 13 shows an example computing system.

FIG. 14 shows a user with a head mounted display device.

### DETAILED DESCRIPTION

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included herein are schematic and generally not drawn to scale. Rather, the various drawing scales, aspect ratios, and numbers of components shown in the figures may be purposely distorted to make certain features or relationships easier to see.

Virtual reality systems allow a user to become immersed to varying degrees in a simulated virtual environment. In order to render an immersive feeling, the virtual environment may be displayed to the user via a head-mounted display (HMD). The present disclosure describes systems and methods that allow a user to interact with their physical environment and incorporate real-world elements from the physical environment into the virtual environment.

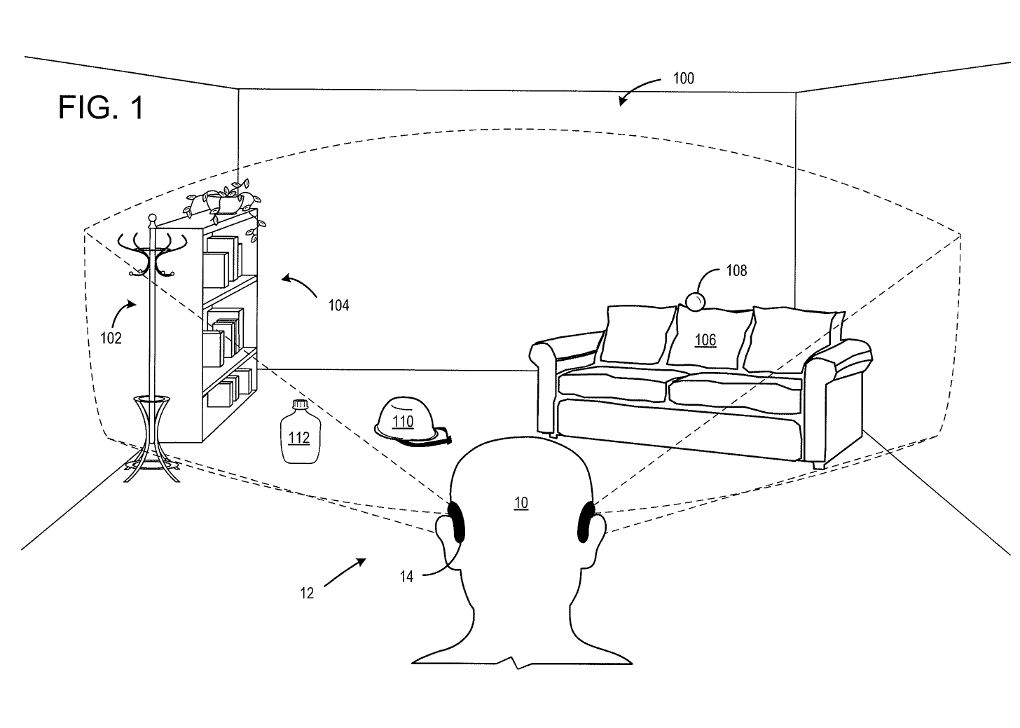

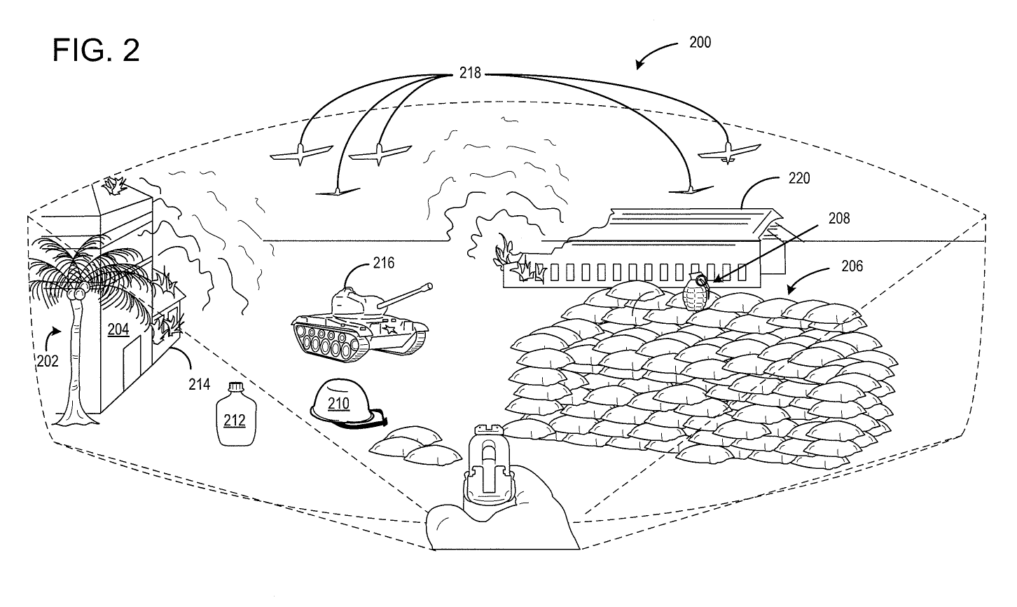

FIG. 1 shows an example physical environment 100 and FIG. 2 shows an example integrated virtual environment 200 that corresponds to physical environment 100.

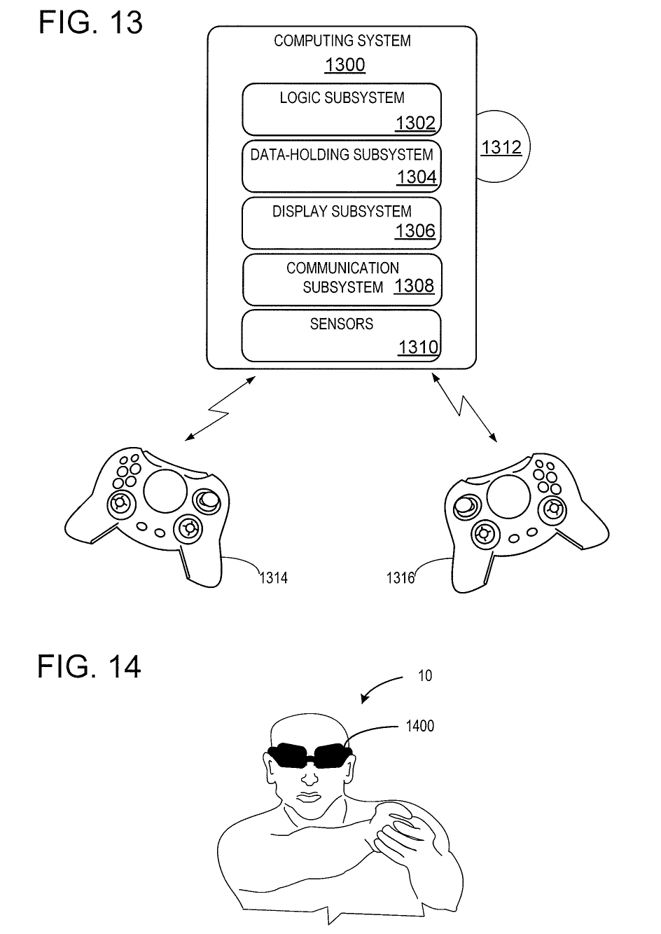

Referring first to FIG. 1, a user 10 is located within physical environment 100. FIG. 1 also includes gaming system 12 which may enable user 10 to be immersed within a virtual environment. Gaming system 12 may be used to play a variety of different games, play one or more different media types, and/or control or manipulate non-game applications and/or operating systems. Gaming system 12 may include display device 14, which may be used to present game visuals to game players. As one example, display device 14 may be a HMD and may be configured to be worn by user 10 to display a three-dimensional (3D) virtual environment. In general, gaming system 12 is a computing system and will be discussed in greater detail with respect to FIGS. 13-14.

Turning back to FIG. 1, physical environment 100 may include one or more physical objects such as physical objects 102, 104, 106, 108, 110, and 112. Such physical objects may be incorporated into a virtual environment. In this way, user 10 may navigate around the physical objects, and may interact with the physical objects while immersed in a virtual environment.

For example, FIG. 2 shows an integrated virtual environment 200 from the vantage point of user 10 of FIG. 1. Integrated virtual environment 200 may be part of a video game and is shown as a scene from a combat video game by way of example, and as such, it should be appreciated that other virtual environments are possible. Integrated virtual environment 200 may include one or more virtualized representations of physical objects. For example, virtualized representation 202 is a virtual object that may correspond to physical object 102 of FIG. 1. As such, virtualized representation 202 may closely resemble some characteristics of physical object 102. As shown, virtualized representation 202 is displayed as a palm tree, which closely resembles the dimensions of physical object 102, shown in FIG. 1 as a coat rack. Likewise, virtualized representations 204, 206, and 208 may match at least some characteristics of physical objects 104, 106, and 108 respectively.

Further, integrated virtual environment 200 may further include one or more virtual objects, such as virtual objects 214, 216, 218, and 220 that do not correspond to a physical object. As such, virtual objects 214, 216, 218, and 220 may be virtual objects of an existing virtual environment associated with a particular video game. When an existing virtual environment further includes virtualized representations of physical objects, such as those discussed above, the existing virtual environment may be referred to as an integrated virtual environment, such as integrated virtual environment 200.

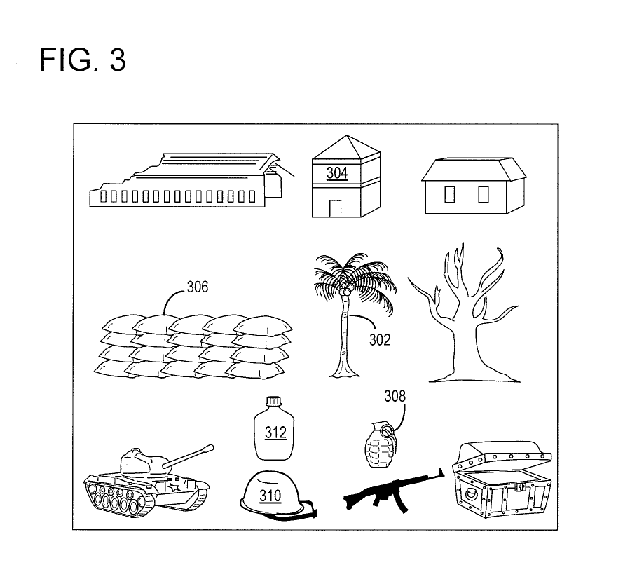

Using the combat game scenario as an example, a virtualized representation of a physical object may be selected from one of a plurality of candidate virtualized representations based on characteristics of the physical object. For example, FIG. 3 illustrates a plurality of candidate virtualized representations 300 that may correspond to an existing virtual environment, such as a combat video game. After selecting a candidate virtualized representation, a gaming system may modify the appearance of the candidate virtualized representation to more closely match at least one characteristic of the physical object. In this way, the physical object may be incorporated into an existing virtual environment with a virtualized representation of that physical object.

As non-limiting examples, a gaming system may consider one or more characteristics of a physical object such as geometric shape, geometric size, weight and/or textile feel. One or more said characteristics may be used to match a physical object to a virtualized representation. For example, the system may recognize that physical objects 102 and 104 have a geometric shape similar to candidates 302 and 304 respectively and select candidates 302 and 304 as virtualized representations of their respective physical objects. The system may modify the appearance, such as the size and/or the perspective view of candidates 302 and 304, to more closely match the dimensions of physical objects 102 and 104. For example, as shown in FIG. 1, physical object 102 is displayed as a coat rack. The gaming system may recognize candidate 302 as a good match for physical object 102 because candidate 302 is a palm tree, and the shape of the trunk and branches of the palm tree closely resemble the shape of the coat rack.

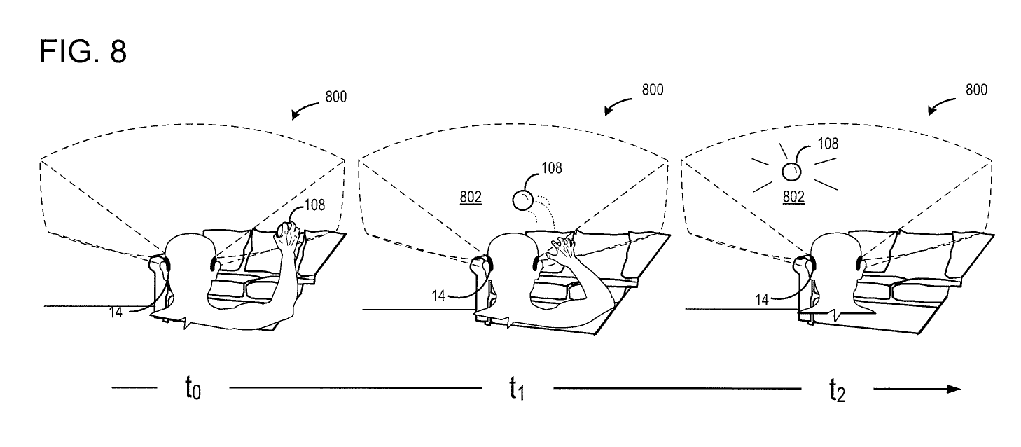

As another example, the system may recognize that physical object 106 is heavy and select candidate 306 as a virtual representation for physical object 106. The system may modify, for example, the number of sandbags and/or the configuration of the sandbags to closely resemble the geometric size and geometric shape of physical object 106, which is depicted in FIG. 1 as a couch. In this way, the couch may be incorporated into the integrated virtual environment as a protective barrier, shielding the game player from virtual enemies. Further, a game player may interact with the physical environment to; for example, increase the size and/or configuration of the sandbags. For example, a game player may push two couches together which may be incorporated into the integrated virtual environment as a larger protective barrier. Examples of a user interacting with the physical environment and having those interactions translate to and become incorporated with the integrated virtual environment will be discussed in greater detail with respect to FIGS. 8, 9, and 12.

As another example, the system may recognize that physical object 108, depicted in FIG. 1 as a ball, is lightweight and has a soft textile feel. As such, the system may select candidate 308, shown in FIG. 3 as a grenade, as a virtualized representation of the ball.

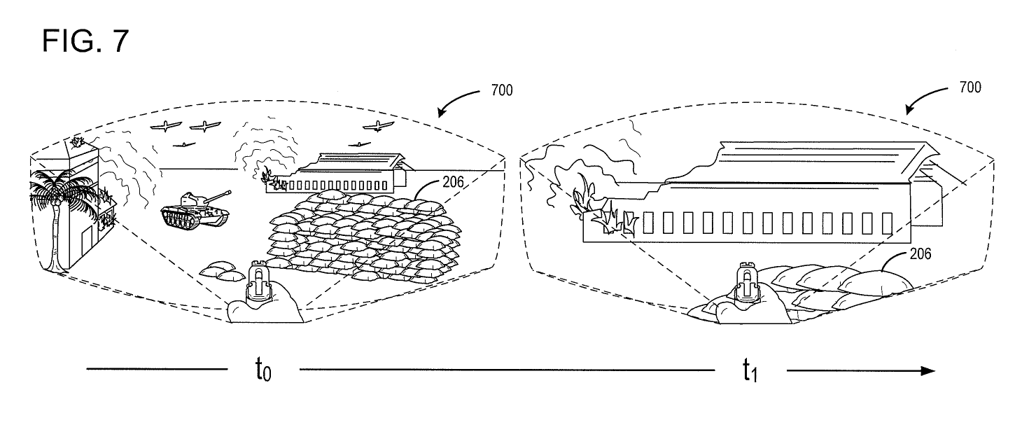

It will be appreciated that some physical objects may be incorporated into an existing virtual environment such that their virtual representation is substantially the same as the physical object. Such objects may be virtually rendered with substantially few modifications. Using the combat game as a non-limiting example, a physical environment may include a helmet 110 and/or a canteen 112 that the system may incorporate into the virtual environment as a virtual helmet 310 and virtual canteen 312 for the user to interact with. User interaction with virtualized representations of physical objects will be discussed in greater detail with respect to FIGS. 7 and 8.

Alternatively, in a semi-transparent virtual environment, physical objects that are already compatible with the existing virtual environment may be visually displayed to the user without creating a virtual representation of the physical object. For example, since a helmet and a canteen are listed as candidates in FIG. 13, the gaming system may be configured to recognize the physical objects and display them without creating a virtual representation of the helmet and the canteen within the existing virtual environment.

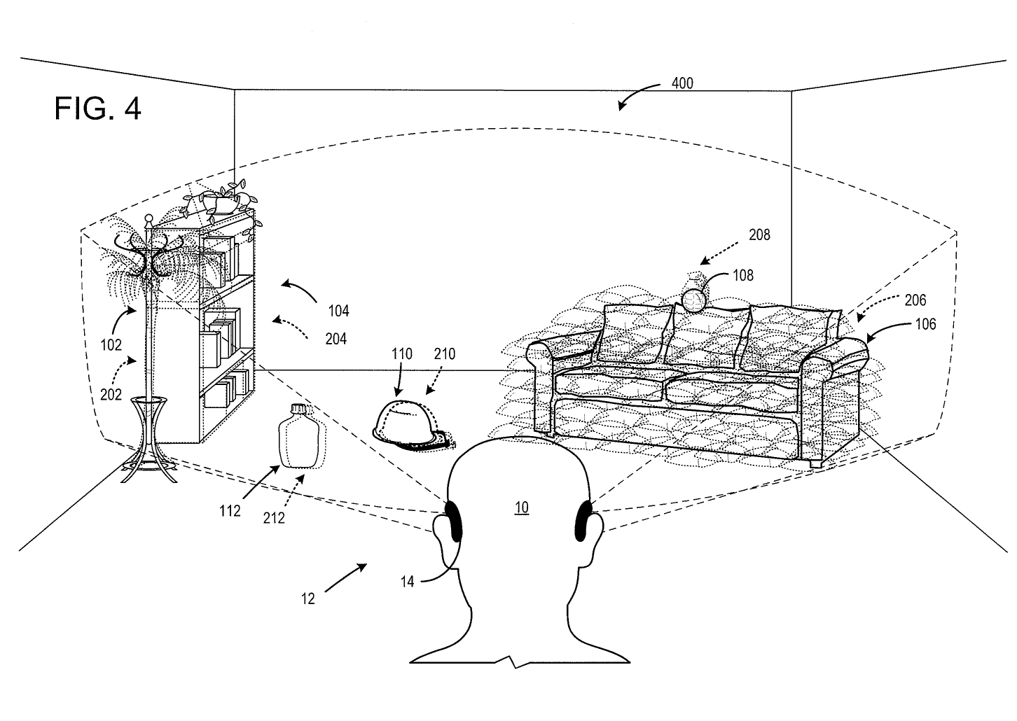

FIG. 4 shows the physical objects of FIG. 1 and their respective virtualized representations of FIG. 2 in an example spatial relationship 400. As shown, a virtualized representation 202 may be incorporated into an existing environment such that virtualized representation 202 occupies substantially the same space/location from the user's perspective as physical object 102. Likewise, virtualized representations 204, 206, and 208 may be incorporated into an existing environment such that they occupy substantially the same space/location as physical objects 104, 106, and 108. In this way, virtualized representations of physical objects may be placed in the existing virtual environment based on a spatial relationship between the user and the physical objects.

In some embodiments, the virtualized representations of the physical objects may occupy a greater or lesser geometric space than the physical objects, and/or may differ to some degree in exact location. In such cases, the geometric center of the virtualized representations may substantially align with the geometric center of their respective physical objects in order to maintain a spatial relationship between the user and the physical objects. However it will be appreciated that other configurations are possible in order to maintain a spatial relationship.

While FIG. 4 shows physical objects with overlaid virtualized representations, this is not meant to be limiting and is provided by way of example. It will be appreciated that a display device may display a fully opaque virtual environment or a semi-transparent virtual environment without departing from the spirit of this disclosure. Further, the environment illustrated as spatial relationship 400 may additionally or alternatively include physical objects, virtualized representations, and/or virtual objects not shown in FIG. 4.

The methods and processes described herein may be tied to a variety of different types of computing systems. FIG. 1 shows a non-limiting example in the form of gaming system 12, and display device 14. In general, a gaming system may include a computing system 1300, shown in simplified form in FIG. 13, which will be discussed in greater detail below.

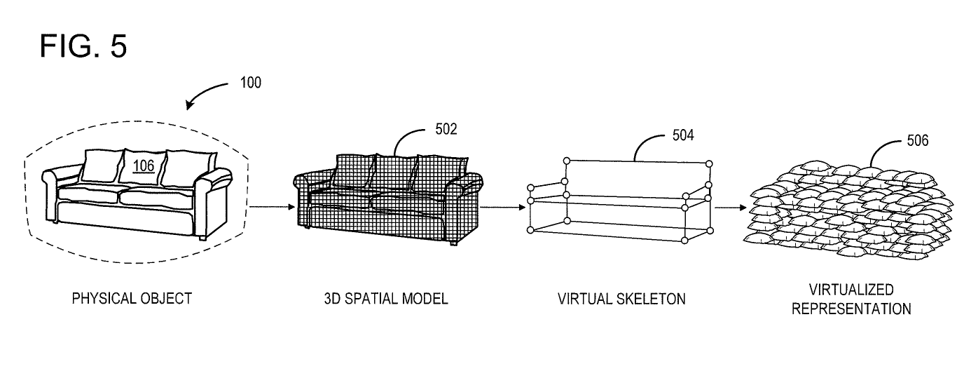

FIG. 5 shows a simplified processing pipeline in which physical object 106 within physical environment 100 is spatially modeled so that the resulting model can be used to select and render an appropriate virtualized representation 506 on a display device. It will be appreciated that a processing pipeline may include additional steps and/or alternative steps than those depicted in FIG. 5 without departing from the scope of this disclosure.

As shown in FIG. 5, physical object 106 and the rest of physical environment 100 may be modeled as a 3D spatial model 502. As shown, 3D spatial model 502 is schematically illustrated as a grid of physical object 106. This illustration is for simplicity of understanding, not technical accuracy. It is to be understood that a 3D spatial model generally includes information from the entire physical environment, not just information from physical object 106.

Virtually any object recognition and/or scene capture technology may be used without departing from the scope of this disclosure. As one example, structured light 3D scanners may determine the geometry of physical object 106 within physical environment 100. Example object recognition and/or scene capture technologies are further discussed below with reference to FIGS. 13-14.

In some cases, such as with objects that have moving parts, the 3D spatial model 502 may include or be used to generate a virtual skeleton 504. Virtual skeleton 504 may be derived from 3D spatial model 502 to provide a machine readable representation of physical object 106. In other words, virtual skeleton 504 is derived from or included as part of 3D spatial model 502 to model physical object 106. The virtual skeleton 504 may be generated in any suitable manner. In some embodiments, one or more skeletal fitting algorithms may be applied. The present disclosure is compatible with virtually any skeletal modeling techniques.

The virtual skeleton 504 may include a plurality of joints, each joint corresponding to a feature of the physical object. In FIG. 5, virtual skeleton 504 is illustrated as a fourteen-joint stick figure. This illustration is for simplicity of understanding, not technical accuracy. Virtual skeletons in accordance with the present disclosure may include virtually any number of joints, each of which can be associated with virtually any number of features (e.g., frame position, cushion position, etc.). It is to be understood that a virtual skeleton may take the form of a data structure including one or more parameters for each of a plurality of skeletal joints (e.g., a joint matrix including an x position, a y position, a z position). In some embodiments, other types of virtual skeletons may be used (e.g., a wireframe, a set of shape primitives, etc.).

As shown in FIG. 5, a virtualized representation 506 may be rendered on a display device as a visual representation of physical object 106. Because virtualized representation 506 models physical object 106, and the rendering of the virtualized representation 506 is based on the physical object 106, the virtualized representation 506 serves as a viewable digital representation of the physical object 106.

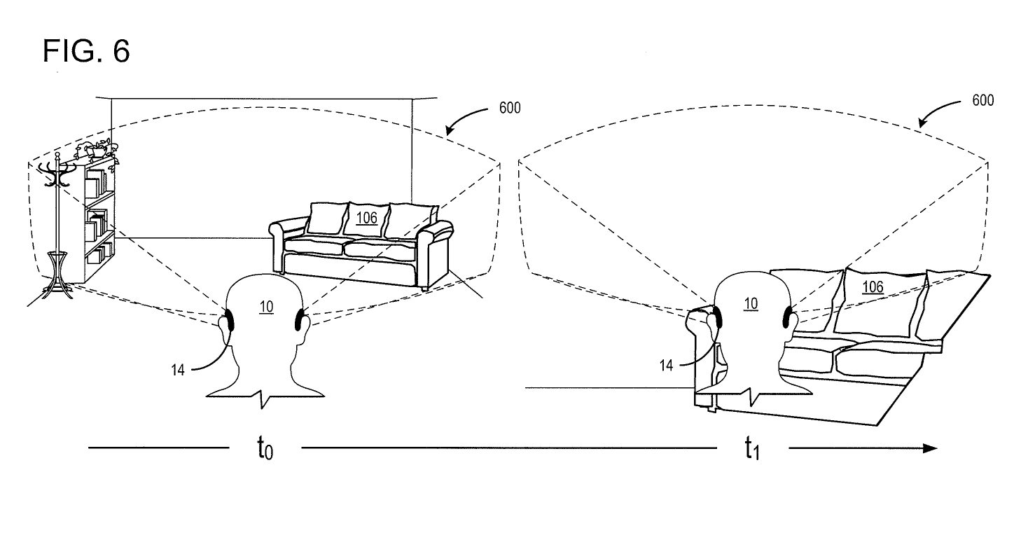

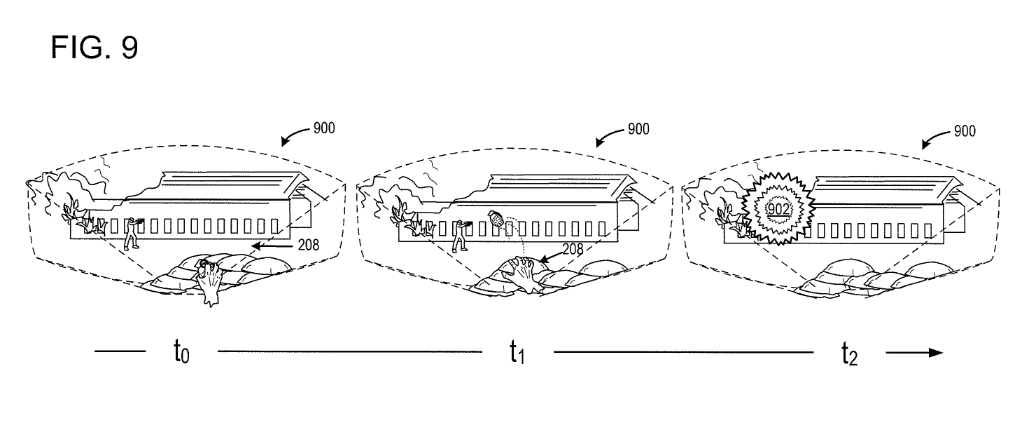

In some scenarios, a virtualized representation may be changed. As one non-limiting example, a user may move relative to the physical object and thus the virtualized representation may move within the integrated virtual environment. Therefore, depending on the vantage point of the user, the perspective view of the virtualized representation within the integrated virtual environment may change. Such an example will be discussed in greater detail with respect to FIGS. 6 and 7. In another example, a user may interact with a physical object (e.g., pick it up, carry it, throw it, alter its configuration, etc.) and thus may modify the position and/or appearance of the virtualized representation within the integrated virtual environment. Such an example will be discussed in greater detail with respect to FIGS. 8 and 9.

As introduced above, a 3D virtual reality combat game may incorporate physical objects as virtualized representations within an existing virtual environment via 3D spatial modeling, thus creating an integrated virtual environment. Within such an environment a game player may interact with the physical environment in various ways and have such interactions translate to the integrated virtual environment. This translation can result in modifying gameplay sequences of the video game.

For a first example, FIG. 6 schematically shows a game player 10 in a physical environment 600 at different moments in time (e.g., time t₀, and time t₁) that corresponds to FIG. 7, which schematically shows a game play sequence that may be derived from detecting the user moving within the physical environment of FIG. 6. At time t₀, game player 10 wearing display device 14 observes physical environment 600, which may include one or more physical objects incorporated into integrated virtual environment 700. As described above, display device 14 may display integrated virtual environment 700 to game player 10.

At time t₁, game player 10 moves within physical environment 600 such that game player 10 is closer to physical object 106. Such a movement may change integrated virtual environment 700 by changing the perspective view and/or scale of virtualized representation 206 of the physical object. In this way, a game player moving relative to the physical object may modify a gameplay sequence of a video game. For example, as shown, the game player may use physical object 106 (and thus virtualized representation 206) as a protective barrier from virtual enemies. In other words, the computing system translates the position of the game player relative to the physical object and translates this position to the integrated virtual environment to maintain a spatial relationship between the user and the physical object. In this way, the gameplay sequence is modified in response to the user moving relative to a physical object. Thus, in the example provided, the combat gameplay sequence may be modified to include the avatar being protected from enemy fire as a result of the game player moving to hide behind the couch.

As another example, FIG. 8 schematically shows a game player 10 in a physical environment 800 at different moments in time (e.g., time t₀, time t₁, and time t₂) that corresponds to FIG. 9, which schematically shows a gameplay sequence that may be derived from detecting the user interacting with the physical environment of FIG. 8. At time t₀, game player 10 wearing display device 14 observes physical environment 800, which may include one or more physical objects incorporated into integrated virtual environment 900. As shown at time t₀, game player 10 may extend a hand to grasp physical object 108. As described above, a gaming system may recognize physical object 108 as a soft and lightweight object and thus may display virtualized representation 208 within integrated virtual environment 900, shown in FIG. 9 as a grenade.

At time t₁, game player 10 throws physical object 108. Such an interaction may change integrated virtual environment 900 by moving virtualized representation 206 of the physical object within integrated virtual environment 900.

At time t₂, physical object 108 hits wall 802 which may correspond to virtualized representation 208 exploding at 902. In this example, the game player interaction with the physical object modifies the appearance of virtualized representation 208 within integrated virtual environment 900. In this way, a game player may interact with the physical object to modify a gameplay sequence of a video game. For example, as shown, the game player may use physical object 108 (and thus virtualized representation 208) as a weapon to combat virtual enemies. In other words, the computing system translates the interaction of the game player with the physical object and translates this interaction such that it is included within the integrated virtual environment. In some embodiments, the position, velocity, or other attributes of one or more physical objects may be taken into consideration. In this way, the gameplay sequence is modified in response to the user interacting with a physical object. Thus, in the example provided, the combat gameplay sequence may be modified to include the avatar throwing a grenade at an enemy as a result of the game player throwing a ball.

As other non-limiting example, a game player may interact with the physical environment by pushing or knocking a physical object over. Such an interaction may modify the gameplay sequence. Using the combat game as an example, pushing a coffee table to a new location within the physical environment may modify the gameplay sequence by pushing a rock to uncover a trap door. It will be appreciated that the above examples are provided as non-limiting examples of a game player interacting with the physical environment and incorporating those interactions into the integrated virtual environment. As such, it will be understood that other user interactions are possible without departing from the scope of this disclosure.

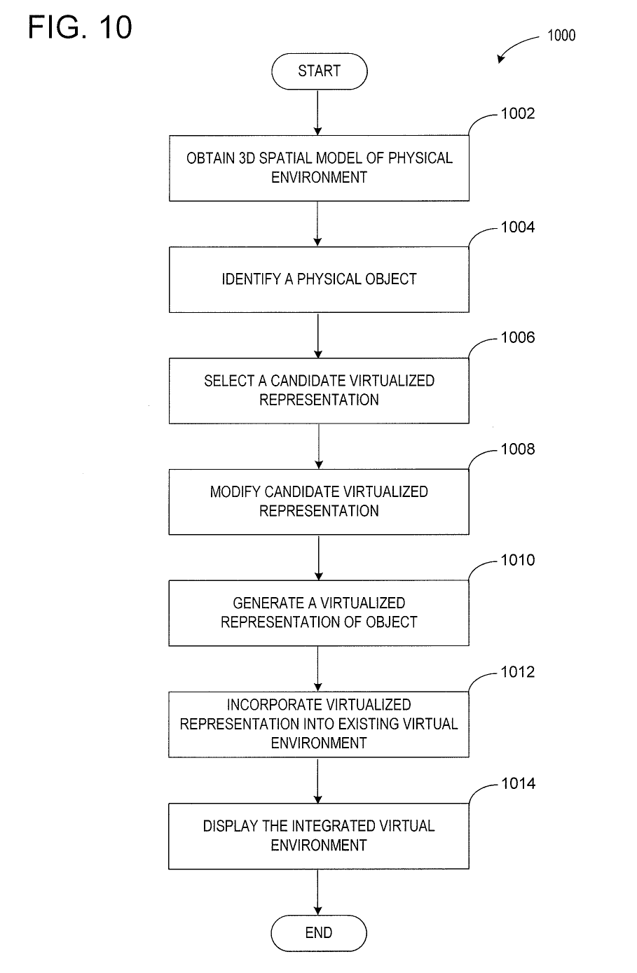

FIG. 10 illustrates an example method 1000 for displaying an integrated virtual environment. At 1002, the method begins with obtaining a 3D spatial model of a physical environment in which a user is located. For example, the 3D spatial model may be obtained by gathering information about the physical environment optically. Further, the information may be obtained in real time such that the user may have a more pleasurable and dynamic gaming experience.

At 1004, the method includes identifying a physical object within the physical environment via analysis of the 3D spatial model. At 1006, the method includes selecting one of a plurality of candidate virtualized representations based on one or more characteristics of the physical object, as described above. At 1008, the method includes modifying said one of the plurality of candidate virtualized representations based on the one or more of said characteristics of the physical object. At 1010, the method includes generating a virtualized representation of the physical object.

At 1012, the method includes incorporating the virtualized representation of the physical object into an existing virtual environment, thereby yielding the integrated virtual environment. As described above, the virtualized representation may be incorporated by placing the virtualized representation of the physical object within the existing virtual environment based on a spatial relationship between the user and the physical object. In this way, real-world physical elements may be incorporated into a virtual environment.

At 1014, the method includes displaying a view of the integrated virtual environment on a display device. The integrated virtual environment may be displayed from a vantage point of the user, for example. Further, the view of the integrated virtual environment may be changeable in response to the user moving within the physical environment.

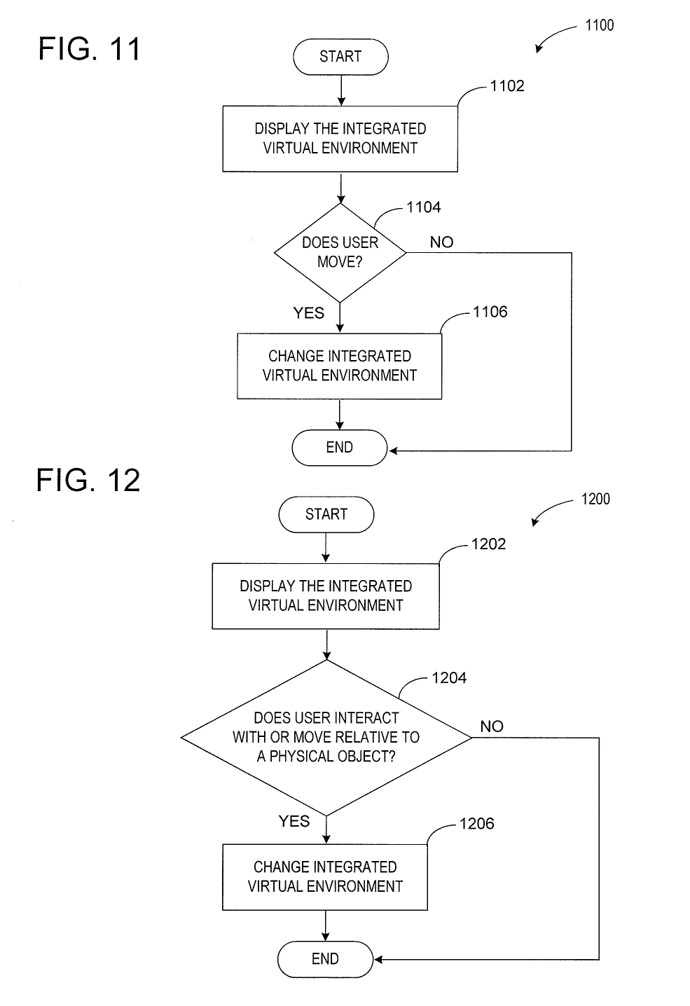

FIG. 11 illustrates an example method 1100 for changing the integrated virtual environment. At 1102, the method begins with displaying a view of the integrated virtual environment on a display device. At 1104, the method includes detecting if the user is moving relative to a physical object. If the answer to 1104 is no, method 1100 ends. If the answer to 1104 is yes, method 1100 continues to 1106.

At 1106, the method includes changing the integrated virtual environment in response to detecting the user physically moving relative to the physical object. In other words, changing the integrated virtual environment comprises translating a physical user movement relative to the physical object into a virtual movement relative to the virtualized representation of the physical object. For example, if the integrated virtual environment is part of a video game the method at 1106 comprises modifying a gameplay sequence of the video game in response to detecting the user physically moving relative to the physical object, as described above in reference to FIGS. 6 and 7.

FIG. 12 illustrates another example method 1200 for changing the integrated virtual environment and/or virtual representation of the physical object. At 1202, the method begins with displaying a view of the integrated virtual environment on a display device. At 1204, the method includes detecting if the user is physically interacting with a physical object. If the answer to 1204 is no, method 1200 ends. If the answer to 1204 is yes, method 1200 continues to 1206.

At 1206, the method includes changing the integrated virtual environment in response to the user physically interacting with or moving relative to the physical object. This can include changing the virtualized representation of the physical object, for example, by moving and/or modifying the appearance of the virtualized representation of the physical object within the integrated virtual environment. In other words, changing the virtualized representation of the physical object (and thus changing the integrated virtual environment) comprises translating a physical user interaction with, or movement relative to, the physical object into an avatar interaction with, or movement relative to, the virtualized representation of the physical object. As indicated above, the integrated virtual environment may be part of a video game, and thus changing the integrated virtual environment and/or virtualized representation of the physical object may modify the gameplay sequence of the video game, as described above in reference to FIGS. 6, 7, 8 and 9.

While described with reference to a 3D virtual combat video game, the integrated virtual environment described above may be applied to other games or applications. Furthermore, the integrated virtual environment described above may be used as a training tool, such as a flight simulator for training pilots. Further, while the above description relates to displaying an integrated virtual environment derived from an indoor physical environment, it will be appreciated that an integrated virtual environment may be derived from an outdoor physical environment.

In some embodiments, the gaming system may be configured for global positioning. As such, global positioning data may be included as information for generating a 3D spatial model of the physical environment. In this way, one or more users and/or one or more physical objects may be tracked with global positioning and this data may be translated to an integrated virtual environment.

In some embodiments, the above described methods and processes may be tied to a computing system comprising one or more computers. In particular, the methods and processes described herein may be implemented as a computer application, computer service, computer API, computer library, and/or other computer program product.

FIG. 13 schematically shows a nonlimiting computing system 1300 that may perform one or more of the above described methods and processes. For example, computing system 1300 may be a gaming system. As such, computing system 1300 may be configured to obtain information about a physical environment and incorporate such information into an existing virtual environment. For example, computing system 1300 may acquire a three-dimensional (3D) spatial model of a physical environment. The 3D model may include information pertaining to one or more physical objects, as described above. Additionally, the 3D model may include information about the position and/or movement of one or more users within the physical environment.

FIG. 13 shows computing system 1300 in simplified form. It is to be understood that virtually any computer architecture may be used without departing from the scope of this disclosure. In different embodiments, computing system 1300 may take the form of a mainframe computer, server computer, desktop computer, laptop computer, tablet computer, home entertainment computer, network computing device, mobile computing device, mobile communication device, gaming device, etc.

Computing system 1300 includes a logic subsystem 1302 and a data-holding subsystem 1304. Computing system 1300 may optionally include a display subsystem 1306, communication subsystem 1308, one or more sensors 1310 and/or other components not shown in FIG. 13. Computing system 1300 may also optionally include user input devices such as keyboards, mice, game controllers (e.g., controllers 1314 and 1316), cameras, microphones, and/or touch screens, for example.

Logic subsystem 1302 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result. As described above, such instructions may be executable by a logic subsystem to provide an integrated virtual environment incorporating real-world physical elements. Further, the instructions may be executable to detect the user physically interacting with, or moving relative to, a physical object via information obtained via one or more sensors 1310.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 1304 may include one or more physical, non-transitory, devices wherein such devices are configured to hold data and/or instructions executable by the logic subsystem to implement the herein described methods and processes. When such methods and processes are implemented, the state of data-holding subsystem 1304 may be transformed (e.g., to hold different data).

Data-holding subsystem 1304 may include removable media and/or built-in devices. Data-holding subsystem 1304 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 1304 may include devices with one or more of the following characteristics: volatile, nonvolatile, dynamic, static, read/write, read-only, random access, sequential access, location addressable, file addressable, and content addressable. In some embodiments, logic subsystem 1302 and data-holding subsystem 1304 may be integrated into one or more common devices, such as an application specific integrated circuit or a system on a chip.

FIG. 13 also shows an aspect of the data-holding subsystem in the form of removable computer-readable storage media 1312, which may be used to store and/or transfer data and/or instructions executable to implement the herein described methods and processes. Removable computer-readable storage media 1312 may take the form of CDs, DVDs, HD-DVDs, Blu-Ray Discs, EEPROMs, and/or floppy disks, among others.

It is to be appreciated that data-holding subsystem 1304 includes one or more physical, non-transitory devices. In contrast, in some embodiments or aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module,” “program,” and “engine” may be used to describe an aspect of computing system 1300 that is implemented to perform one or more particular functions. In some cases, such a module, program, or engine may be instantiated via logic subsystem 1302 executing instructions held by data-holding subsystem 1304. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

Display subsystem 1306 may be used to present a visual representation of data held by data-holding subsystem 1304. As the herein described methods and processes change the data held by the data-holding subsystem, and thus transform the state of the data-holding subsystem, the state of display subsystem 1306 may likewise be transformed to visually represent changes in the underlying data. Display subsystem 1306 may include one or more display devices utilizing virtually any type of technology. Such display devices may be combined with logic subsystem 1302 and/or data-holding subsystem 1304 in a shared enclosure, or such display devices may be peripheral display devices.

For example, FIG. 14 shows a perspective view of a user 10 wearing a display device which is shown as a head-mounted display (HMD) 1400. As shown, HMD 1400 may be configured so as to be worn by a user and may resemble glasses, although it will be appreciated that other configurations are possible. In this way, the display device may be remotely coupled to computing system 1300 to enable a user to see visuals displayed on display device 1400 without being directly coupled to computing system 1300. As another example, a computing system may include a display device that comprises a head-up display. Virtually any technology that enables virtual environment immersion is possible. Further, the display device may be configured to display a fully opaque virtual environment, or the display device may be configured to display a semi-transparent virtual environment, which are provided as non-limiting examples.

Turning back to FIG. 13, when included, communication subsystem 1308 may be configured to communicatively couple computing system 1300 with one or more other computing devices. Communication subsystem 1308 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow computing system 1300 to send and/or receive messages to and/or from other devices via a network such as the Internet.

For example, communication subsystem 1308 may enable more than one integrated virtual environment corresponding to more than one physical environment to be networked. In such cases, the one or more integrated virtual environments may be combined into a merged integrated virtual environment incorporating one or more physical objects from each of the physical environments. In this way, game players may play a networked game in a merged integrated virtual environment that each game player may interact with.

Computing system 1300 may include one or more sensors 1310 configured to obtain information about the physical environment. The one or more sensors 1310 may be configured to obtain information optically and in real time. For example, the one or more sensors 1300 may comprise an image capture device configured to obtain one or more depth images of the physical environment. As additional non-limiting examples, computing system 1300 may be operatively coupled to one or more laser range finders, time of flight cameras, and/or structured light 3D scanners. Such technologies may be directly coupled and/or remotely linked to computing system 1300. As one example, one or more sensors 1310 may be included in a display device, such as HMD 1400. As another example, one or more sensors 1310 may be remotely linked to computing system 1300 and HMD 1400. In this way, one or more sensors 1310 may be placed at different positions within an environment, and as such, may be wirelessly linked to computing system 1300. The one or more sensors 1300 may be configured to obtain information regarding the position of a user and/or one or more physical objects. In this way, the sensors may detect the position and movement of the user within the physical environment based on a spatial relationship between the user and the one or more physical objects.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of providing an integrated virtual environment incorporating real-world physical elements, the method comprising:
obtaining a 3D spatial model of a physical environment in which a user is located;
identifying, via analysis of the 3D spatial model, a physical object in the physical environment;
generating a virtualized representation of the physical object;
incorporating the virtualized representation of the physical object into an existing virtual environment, thereby yielding the integrated virtual environment; and
displaying, on a display device and from a vantage point of the user, a view of the integrated virtual environment, said view being changeable in response to the user moving within the physical environment.

2. The method of claim 1, wherein generating the virtualized representation of the physical object comprises selecting one of a plurality of candidate virtualized representations based on one or more characteristics of the physical object and modifying said one of the plurality of candidate virtualized representations based on one or more of said characteristics.

3. The method of claim 2, wherein the plurality of candidate virtualized representations correspond to the existing virtual environment.

4. The method of claim 1, wherein obtaining the 3D spatial model of the physical environment comprises obtaining information about the physical environment optically and in real time.

5. The method of claim 1, further comprising changing the virtualized representation of the physical object in response to detecting the user physically interacting with the physical object.

6. The method of claim 5, wherein changing the virtualized representation of the physical object comprises moving the virtualized representation of the physical object within the integrated virtual environment.

7. The method of claim 5, wherein changing the virtualized representation of the physical object comprises modifying an appearance of the virtualized representation of the physical object within the integrated virtual environment.

8. The method of claim 1, wherein the integrated virtual environment is part of a video game, the method further comprising modifying a gameplay sequence of the video game in response to detecting the user physically interacting with the physical object.

9. The method of claim 1, wherein the integrated virtual environment is part of a video game, the method further comprising modifying a gameplay sequence of the video game in response to detecting the user moving relative to the physical object.

10. The method of claim 1, wherein incorporating the virtualized representation of the physical object into the existing virtual environment comprises placing the virtualized representation of the physical object in the existing virtual environment based on a spatial relationship between the user and the physical object.

11. A method of providing an integrated virtual environment incorporating real-world physical elements, the method comprising:
obtaining a 3D spatial model of a physical environment in which a user is located;
identifying, via analysis of the 3D spatial model, a physical object in the physical environment;
generating a virtualized representation of the physical object;
incorporating the virtualized representation of the physical object into an existing virtual environment, thereby yielding the integrated virtual environment;
displaying, on a display device and from a vantage point of the user, a view of the integrated virtual environment, said view being changeable in response to the user moving within the physical environment;
detecting a user physically interacting with or moving relative to the physical object; and
in response, changing the integrated virtual environment.

12. The method of claim 11, wherein changing the integrated virtual environment comprises translating a physical user interaction with the physical object into a virtual interaction with the virtualized representation of the physical object.

13. The method of claim 11, wherein changing the integrated virtual environment comprises moving the virtualized representation of the physical object within the integrated virtual environment.

14. The method of claim 11, wherein changing the integrated virtual environment comprises modifying an appearance of the virtualized representation of the physical object within the integrated virtual environment.

15. A gaming system, comprising:
a display device configured to be worn by a user;
one or more sensors configured to obtain information about a physical environment in which the user is located and detect movement of the user within the physical environment;
a data-holding subsystem operatively coupled with the display and the one or more sensors, the data-holding subsystem configured to hold instructions executable by a logic subsystem to:
obtain a 3D spatial model of the physical environment in which the user is located;
identify, via analysis of the 3D spatial model, a physical object in the physical environment;
generate a virtualized representation of the physical object;
incorporate the virtualized representation of the physical object into an existing virtual environment associated with a video game, thereby yielding the integrated virtual environment;
display, on the display device and from a vantage point of the user, a view of the integrated virtual environment, said view being changeable in response to the user moving within the physical environment; and
in response to detecting the user physically interacting with or moving relative to the physical object, change the integrated virtual environment to thereby modify a gameplay sequence of the video game.

16. The gaming system of claim 15, wherein the instructions are executable to modify the gameplay sequence of the video game by translating a physical user interaction with the physical object into an avatar interaction with the virtualized representation of the physical object.

17. The gaming system of claim 15, wherein the display device comprises a head-mounted display.

18. The gaming system of claim 15, wherein the display device comprises a head-up display.

19. The gaming system of claim 15, wherein the one or more sensors comprise an image capture device configured to obtain one or more depth images of the physical environment.

20. The gaming system of claim 15, wherein the instructions are executable to detect the user physically interacting with or moving relative to the physical object via information obtained via the one or more sensors.
